(19) United States
(12) Patent Application Publication
(10) Pub. No.: US 2015/0375250 A1
(43) Pub. Date: Dec. 31, 2015

(54) Cover Structure of Sprinkler Guns

(71) Applicant: ZHANGZHOU LEYUAN INDUSTRIAL CO., LTD., ZhangZhou City (CN)

(72) Inventor: Wen Li Kuo, ZhangZhou City (CN)

(21) Appl. No.: 14/548,303

(22) Filed: Nov. 20, 2014

(30) Foreign Application Priority Data
Jun. 25, 2014 (CN) 201420341429.2

(51) Int. Cl. B05B 15/06; B05B 1/14; B05B 1/02

(52) U.S. Cl. CPC B05B 15/065; B05B 1/02; B05B 1/14

(57) ABSTRACT

A cover structure of sprinkler guns comprises a body mounted on a gun body and a netting mounted on the body. The body comprises a non-netted water spout formed thereon. The netting comprises a netted water spout formed thereon. The netting is detachably mounted on the body. A sealing ring is disposed between the netting and the body. When pores of the netted water spout are clogged, the user can detach the netting directly to wash the dirt off from the opposite side of the netting or substitute the new netting for the old one without replacing a whole cover, thereby cleaning the cover conveniently and decreasing the cost of the use.

### BACKGROUND OF THE INVENTION

1. Field of the Invention

The invention pertains to a horticultural tool related to a sprinkler gun which produces the multi-stage spray, particularly to a cover structure of the sprinkler gun.

2. Description of the Related Art

Generally, a conventional horticultural sprinkler gun producing the multi-stage spray is constructed by mounting a water divide on a gun body and mounting a cover on the gun body. The cover has plural stages of water spouts. In use, the water flows into an inlet of the gun body, flows out from an outlet of the gun body and thence flows to the cover through the water divide. Finally, the water squirts from each water spout of the cover, thereby attaining the multi-stage spraying effect.

Each water spout of the conventional sprinkler gun is integrally formed on the cover, including a netted water spout which produces the mist spray and a plurality of holes formed on the netted water spout. However, the holes are easily clogged owing of the worse horticultural water, which causes the water unable to be output and breaks the cover easily. Therefore, the cover needs to be replaced frequently and the cost of the use is much higher.

Consequently, the conventional cover of the sprinkler gun still needs improvements.

### SUMMARY OF THE INVENTION

The object of this invention is to provide a cover structure of the sprinkler guns that facilitates an easy cleaning and decreases the cost of the use.

To obtain the above object, the technique of this invention is described as follows:

The cover structure of sprinkler guns in accordance with this invention comprises a body mounted on a gun body and a netting mounted on the body. The body comprises a non-netted water spout formed thereon. The netting comprises a netted water spout formed thereon. The netting is detachably mounted on the body. A sealing ring is disposed between the netting and the body.

Preferably, the body and the netting are connected by threads and mounted with each other.

Preferably, the body comprises a threaded hole formed thereon. The netting comprises an aperture formed thereon. A screw passes the aperture and engages with the threaded hole so that the netting can be mounted on and fixed to the body.

Preferably, the body comprises a cutout defined thereon. The netting comprises a locking tab disposed thereon. The netting can be mounted on and fixed to the body by having the locking tab in cooperation with the cutout.

From above, the netted water spout of this invention which produces the mist spray is independently formed on the netting, and the netting is detachably mounted on the body. Accordingly, when pores of the netted water spout are clogged, the user can detach the netting directly to wash the dirt off from the opposite side of the netting or substitute the new netting for the old one without replacing a whole cover. Therefore, it is convenient to clean the cover and decreases the cost of the use.

### BRIEF DESCRIPTION OF THE DRAWINGS

FIG. 1 is a schematic view showing a structure of this invention;

FIG. 2 is a cross-sectional view showing this invention;

FIG. 3 is a first exploded view of this invention applied to a sprinkler gun;

FIG. 4 is a second exploded view of this invention applied to a sprinkler gun; and

FIG. 5 is a third exploded view of this invention applied to a sprinkler gun.

### DETAILED DESCRIPTION OF THE PREFERRED EMBODIMENTS

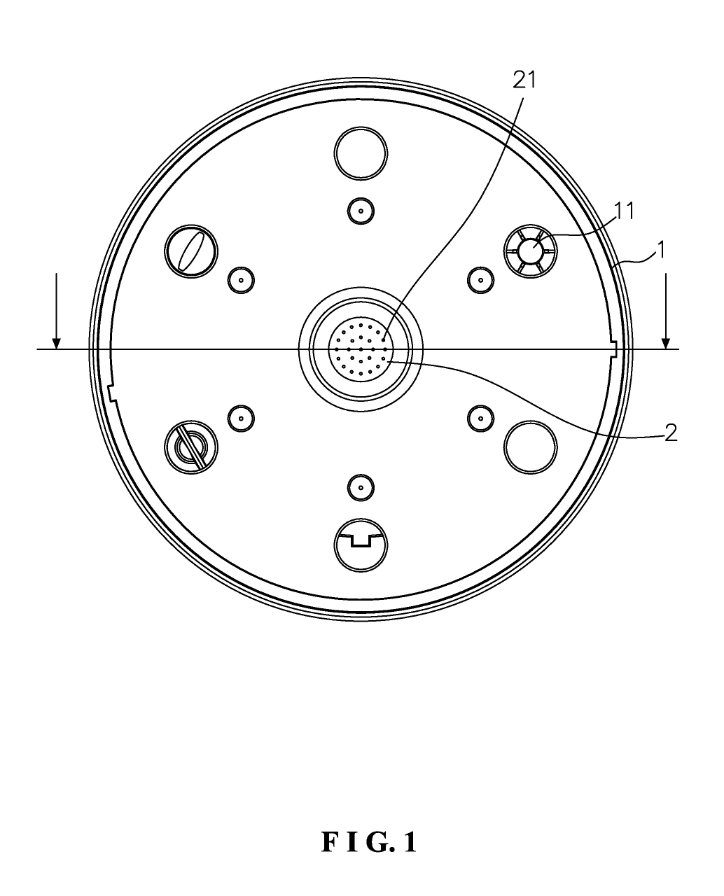

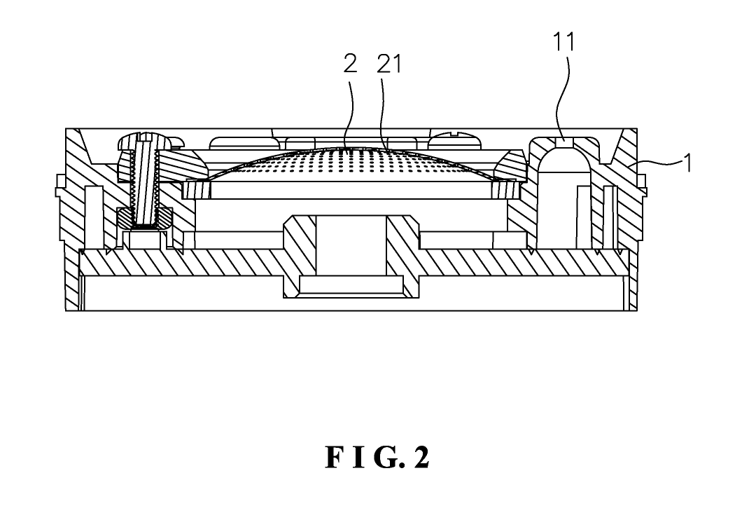

Referring to FIGS. 1 and 2, a cover structure of sprinkler guns comprises a body 1 and a netting 2.

The body 1, the same as the cover of the prior art, is mounted on the gun body 3. The body 1 comprises a multi-stage and non-netted water spout 11 formed thereon.

The netting 2 can be detachably mounted on the body 1. The netting 2 comprises a water spout 21 formed thereon. A sealing ring 4 is disposed between the netting 2 and the body 1.

Accordingly, the netted water spout 21 of this invention which produces the mist spray is independently formed on the netting 2. When pores of the netted water spout are clogged, the user can detach the netting 2 directly to wash the dirt off from the opposite side of the netting or substitute the new netting 2 for the old one without replacing a whole cover. Therefore, it is convenient to clean the cover and decreases the cost of the use.

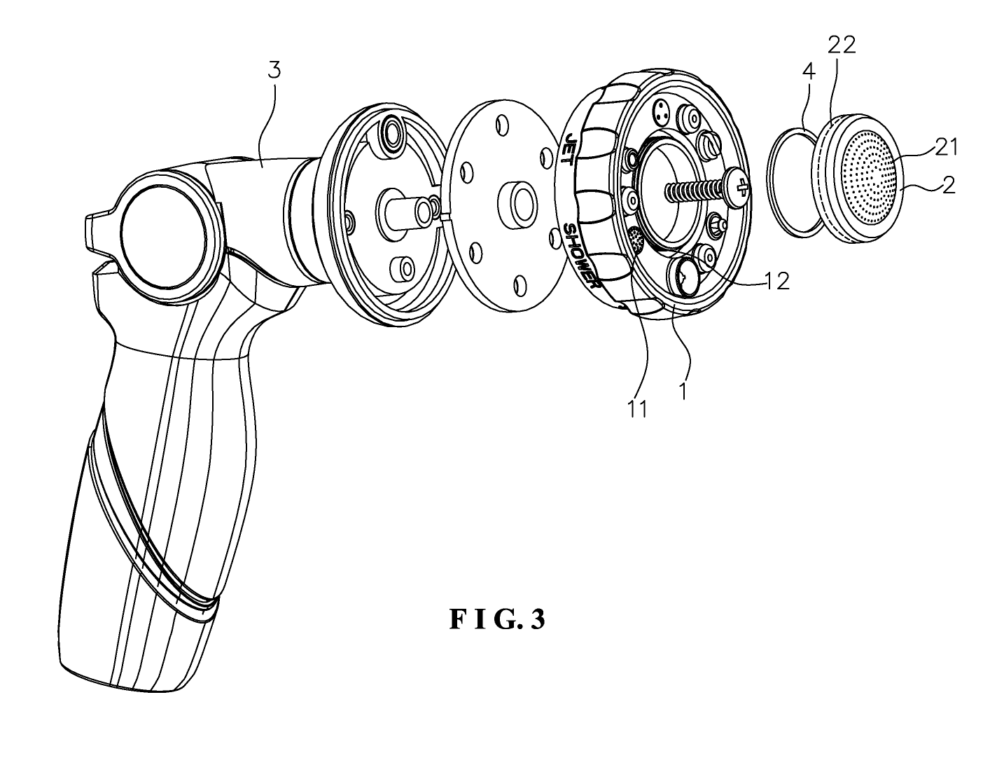

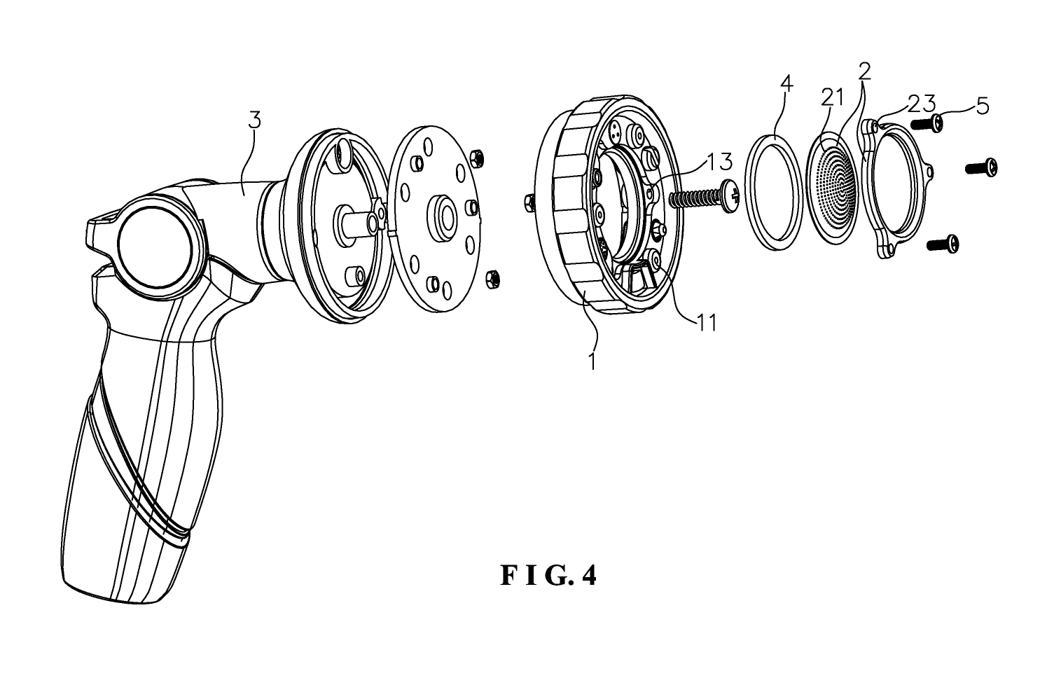

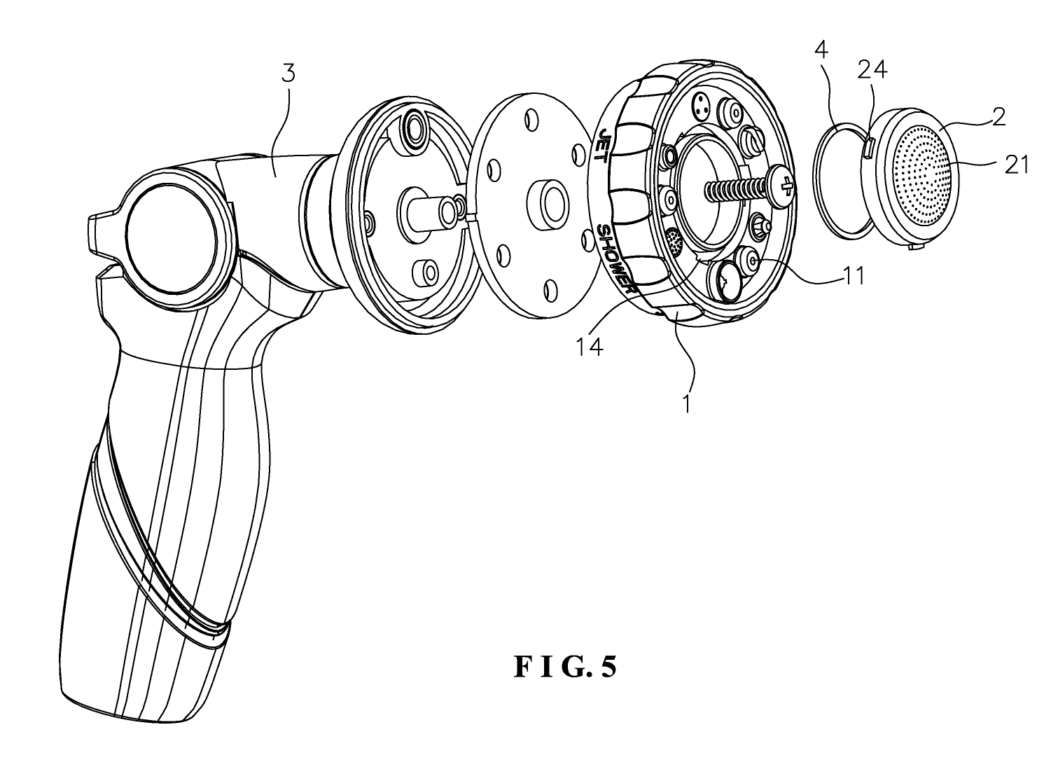

Particularly, this invention can have different ways to detach the structure. For example, FIG. 3 shows that the body 1 and the netting 2 can be connected by threads 12, 22 and mounted with each other. FIG. 4 shows that the body 1 comprises a threaded hole 13 formed thereon, and the netting 2 comprises an aperture 23 formed thereon, whereby a screw 5 can pass the aperture 23 and engage with the threaded hole 13 to allow the netting 2 to be mounted on and fixed to the body 1. FIG. 5 shows that the body 1 comprises a cutout 14 formed thereon, and the netting 2 comprises a locking tab 24 formed thereon. The locking tab 24 in cooperation with the cutout 14 allows the netting 2 to be mounted on and fixed to the body 1. Other suitable detachments of the structure that are not mentioned here can also be adopted, which herein are omitted. While the embodiments in accordance with this invention are described supra, it should be clear to those skilled in the art that further embodiments may be made without departing from the scope of this invention.

What is claimed is:

1. A cover structure of sprinkler guns, characterized in that said structure comprises a body mounted on a gun body and a netting mounted on said body, said body comprising a non-netted water spout formed thereon, said netting comprising a netted water spout formed thereon, said netting being detachably mounted on said body, a sealing ring being disposed between said netting and said body.

2. The cover structure of sprinkler guns as claimed in claim 1, wherein said body and said netting are connected by threads and mounted with each other.

3. A cover structure of sprinkler guns, characterized in that said structure comprises a body mounted on a gun body and a netting mounted on said body, said body comprising a non-netted water spout formed thereon, said netting comprising a netted water spout formed thereon, said body comprising a threaded hole formed thereon, said netting comprising an aperture formed thereon, a screw passing said aperture and engaging with said threaded hole so that said netting is able to be detachably mounted on said body, a sealing ring being disposed between said netting and said body.

4. A cover structure of sprinkler guns, characterized in that said structure comprises a body mounted on a gun body and a netting mounted on said body, said body comprising a non-netted water spout formed thereon, said netting comprising a netted water spout formed thereon, said body comprising a cutout defined thereon, said netting comprising a locking tab disposed thereon, said netting being able to be detachably mounted on said body by said locking tab in cooperation with said cutout, a sealing ring being disposed between said netting and said body.
